(19) United States
(12) Patent Application Publication
(10) Pub. No.: US 2012/0085650 A1
(43) Pub. Date: Apr. 12, 2012

(54) Apparatus and Method for Water and Wastewater Treatment Using Electrocoagulation

(76) Inventor: Donald R. Hartle, Garibaldi Highlands (CA)

(21) Appl. No.: 13/272,052

(22) Filed: Oct. 12, 2011

Related U.S. Application Data
(60) Provisional application No. 61/392,352, filed on Oct. 12, 2010.

(51) Int. Cl. B03C 5/02

(52) U.S. Cl. 204/554; 204/660; 204/671

(57) ABSTRACT

A system for treating wastewater using electrocoagulation in which fouling of the electrodes is greatly reduced or eliminated. The system comprises an anode comprising an anode surface, with an anode surface area, and a cathode comprising a cathode surface, with a cathode surface area greater than or equal to the anode surface area. A power supply is connected to the anode and the cathode and provides direct current at a current density of between 0.2 and 3.0 A/cm² of the anode surface area. The wastewater provides electrical conductivity between the anode surface and the cathode surface.

### CROSS-REFERENCE TO RELATED APPLICATIONS

This application claims the benefit of U.S. Provisional Patent Application No. 61/392,352 filed Oct. 12, 2010, the entire contents of which are hereby incorporated by reference.

### FIELD OF THE INVENTION

The present invention relates to the field of water and wastewater treatment. In particular, the present invention relates to a process and apparatus for water and wastewater treatment using electrocoagulation.

### BACKGROUND OF THE INVENTION

Electrocoagulation is a process for treating wastewater in which an electric current is applied to electrodes through conductive wastewater. During the electrocoagulation process, the positively charged electrode produces anodic reactions, while the negatively charged electrode produces cathodic reactions. Anodes made of iron or aluminum are consumed to produce positively charged ions in the treatment stream to attract the negatively charged contaminant particles and thereby initiate flocculation, resulting in increased particle size. These particles can then be removed by sinking, floatation, or filtration.

Also, during electrocoagulation, hydrolysis of the water produces oxygen, hydrogen, and hydroxyls. As water containing colloidal particulates, oils, metals, or other contaminants move between the electrodes, there may be ionization, electrolysis, oxidation, precipitation, and free radical formation that can alter the physical and chemical properties of contaminants, allowing flocculation and coagulation and hence removal from the treatment stream.

One of the difficulties with conventional electrocoagulation cells is the undesirable tendency for passivation and fouling of the electrodes, caused by a build-up of non-reactive material on the surface of the electrodes. This results in an uneven degree of activity over the electrodes and may lead to plugging and blocking of the treatment flow, the build-up of treatment gases, and the pitting, gouging, and uneven wear of electrode plate surfaces. Pitting and gouging may also cause treatment flow short-circuiting, as the electrodes are perforated. This may lead to untreated water exiting the cell and a need to replace the electrodes long before the bulk of the sacrificial anode material has been utilized. Attempts at overcoming this have involved increasing the surface area of the electrodes and/or changing the routing of the treatment flow to expose the contaminants to a very large electrode area to make up for the passivation and fouling of the electrodes. Switching the electrical polarity on the electrodes has also been attempted to reduce passivation. Other designs have tried to enable improved access to the electrodes for descaling, cleaning, and/or rapid replacement of the electrodes.

Current literature suggests that a relatively low current density should be applied to the electrodes. For example, in Kobya, Mehmet et al., “Treatment of textile wastewaters by electrocoagulation using iron and aluminum electrodes”, Journal of Hazardous Materials: B100 (2003) 163-178, it was suggested that a current density of 80 to 100 A/m² for iron and a current density of 150 A/m² for aluminum was effective for treating textile wastewater using electrocoagulation. However, there is no discussion of countering the fouling of the electrodes, other than by washing the electrodes.

Similarly, in El-Shazly, A. H. et al., “Improvement of NO₃⁻ Removal from Wastewater by Using Batch Electrocoagulation Unit with Vertical Monopolar Aluminum Electrodes”, International Journal of Electrochemical Science: 6 (2011) 4141-4149, suggested that low current density, in the range of 3 to 13 mA/m² was effective in removing NO3⁻ from wastewater using electrocoagulation. Again, there is no discussion of countering the fouling of the electrodes.

The uncontrolled fouling of the electrodes has been a major cause of failure of electrocoagulation cells and has limited the commercial success of such cells. These cells have required a high level of maintenance and have a limited ability to treat water on a commercial scale.

Accordingly there is a need for an electrocoagulation water and wastewater treatment cell that enables the energy efficient and cost-effective removal of contaminants or harvesting of materials that is both easy to use and maintain and at the same time, minimizing the effect of fouling of the electrodes.

### SUMMARY OF THE INVENTION

The present invention is to enable the treatment of wastewater and water for the removal of impurities or the harvesting of products by the use of the process of electrocoagulation when utilized with other processes such as filtration, floatation, and sinking to separate the formed flocs from the clarified stream.

It is also the object of this invention to operate within a current density zone between 0.2 and 3.0 A/cm² of anode surface area in opposition to a cathode surface area equal to or exceeding the same area to preclude fouling of the anode and cathode surfaces.

It is also an object of this invention to provide this process of electrocoagulation in an efficient and cost-effective method.

It is also an object of this invention to provide this process of electrocoagulation in a method that is easy to use and maintain.

It is also the object of this invention to allow the consumption of an anode within a controlled, repeatable and consistent range of current density and flow characteristics.

It is also object of this invention to provide a method to adjust the electrode gap during the continued treatment process by repositioning the cathode to allow for the controlled consumption of the anode.

In one aspect of the invention, a system for treating wastewater comprises an anode, a cathode, and a power supply. The anode comprises an anode surface, with an anode surface area. The cathode comprises a cathode surface, with a cathode surface area greater than or equal to the anode surface area. The power supply is connected to the anode and the cathode and provides direct current to the anode and the cathode at a current density effective to reduce or prevent fouling of the anode and/or the cathode, this current density being between 0.2 and 3.0 A/cm² of the anode surface area. The wastewater provides electrical conductivity between the anode surface and the cathode surface.

In another aspect of the invention, the current density is between 0.24 and 2.0 A/cm² of the anode surface area.

In a further aspect of the invention, the system further comprises a tank and one or more non-conductive spacers. The anode and the cathode are placed in the tank, and the cathode is moveable within the tank. The one or more spacers separate the anode surface from the cathode surface, are attached to the cathode, and are moveable along the anode surface.

In yet a further aspect of the invention, the cathode is substantially cylindrical and is moveable within the tank in a rotational manner about an axis of the cathode.

In a still further aspect of the invention, the anode is comprised of one of the following materials: aluminum alloy, aluminum, or iron. The cathode is comprised of one of the following materials: aluminum, bronze, iron, steel, or stainless steel.

In another aspect of the invention, the cathode comprises an opening through which the wastewater flows. A cathode pipe introduces the wastewater into the tank and is connected to the cathode.

In a further aspect of the invention, the cathode is moveable within the tank through rotation of the cathode pipe.

In a still further aspect of the invention, the cathode pipe comprises an inner pipe located within an interior of the cathode pipe.

In another aspect of the invention, a method for treating wastewater using electrocoagulation comprises the steps of providing an anode comprising an anode surface having an anode surface area; providing a cathode comprising a cathode surface having a cathode surface area greater than or equal to the anode surface area; introducing the wastewater to provide electrical conductivity between the anode surface and the cathode surface; and applying direct current to the cathode and the anode, with a current density effective to reduce or prevent fouling of the cathode and the anode. The current density is between 0.2 and 3.0 A/cm² of said anode surface area.

In a further aspect of the invention, the method further comprises placing the cathode on the anode in a tank, wherein the cathode surface and the anode surface are separated by one or more non-conductive spacers. The one or more spacers are connected to the cathode and rest on the anode surface.

In a yet further aspect of the invention, the method comprises periodically moving the cathode such that the one or more spacers move along the anode surface.

In a still further aspect of the invention, the tank is filled with the wastewater in order to provide electrical conductivity between the anode surface and the cathode surface.

In another aspect of the invention, periodically moving the cathode comprises periodically moving the cathode a distance at least equal to the width of one of the one or more spacers.

These and other objects of the invention will be better understood by reference to the detailed description of the preferred embodiment which follows.

### BRIEF DESCRIPTION OF THE DRAWINGS

The invention will be described by reference to the detailed description of the preferred embodiment and to the drawings thereof in which:

FIG. 1 shows an electrocoagulation cell according to the present invention;

FIG. 2 shows a bottom face of the cathode; and

FIG. 3 shows a side view of the anode and cathode during the electrocoagulation process.

### DETAILED DESCRIPTION OF THE PREFERRED EMBODIMENT

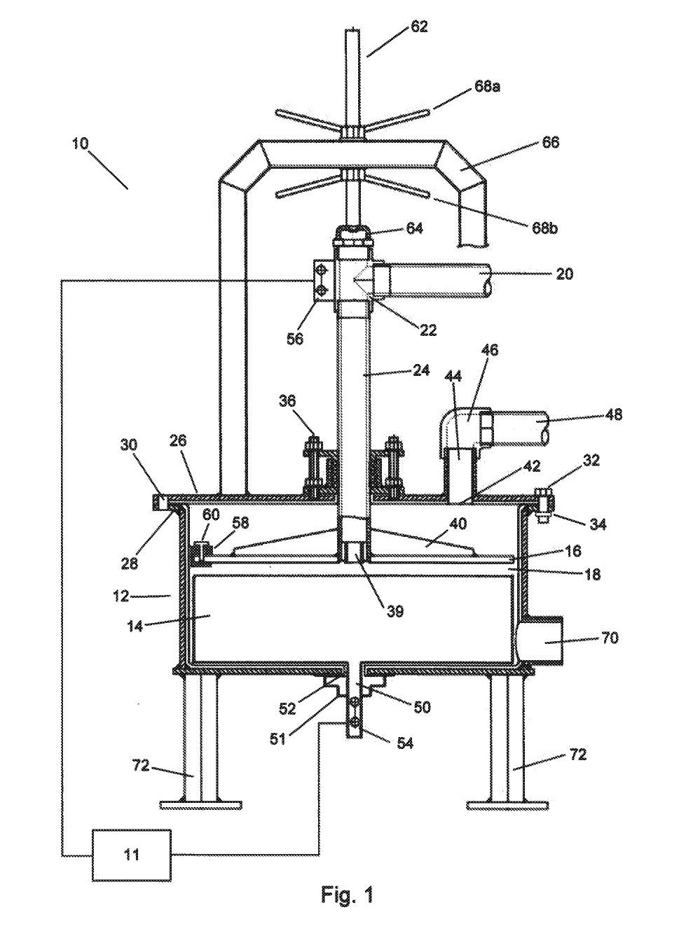

Referring to FIG. 1, an electrocoagulation cell 10 according to one aspect of the present invention comprises a tank 12, an anode 14, and a cathode 16. The tank 12, the anode 14, and the cathode 16 are preferably generally cylindrical in shape; however, both the anode 14 and the cathode 16 have a diameter that is less than the diameter of the tank 12, with both the anode 14 and the cathode 16 placed within the tank 12. The cathode 16 and the anode 14 are preferably placed above one another within the tank 12 and in a spaced relationship from each other, separated by an electrode gap 18. In the preferred embodiment, the electrode gap 18 is defined by the space between the bottom surface of the cathode 16 and the top surface of the anode 14. The cathode 16 may be made of aluminum, bronze, iron, steel, stainless steel, or the like. The anode 14 is preferably made of an aluminum alloy that can be used as a sacrificial anode; however, materials such as aluminum or iron may also be used. The tank 12 is preferably constructed with stainless steel, or some other conductive material, and lined on the inside with a lining 13. The lining 13 may be an insulating material, such as vulcanized rubber. Alternatively, the tank 12 may be constructed with a non-conductive material, such as reinforced resins or plastics.

The flow of wastewater to be treated by the cell 10 begins with a hose (not shown) that introduces the wastewater into a flow entry pipe 20. The wastewater than passes through a flow entry elbow 22 and into a cathode pipe 24. Preferably, the longitudinal axis of the flow entry pipe 20 is arranged substantially horizontally, with the flow entry elbow 22 being a 90-degree angle elbow. Accordingly, the longitudinal axis of the cathode pipe 24 would be arranged substantially vertically.

Preferably, the cell 10 comprises a lid 26 that substantially covers the top surface of the tank 12. The side wall of the tank 12 may form a flange 28 around the top perimeter of the tank 12, with the flange 28 providing a surface on which the lid 26 can rest on top of the tank 12. One or more holes 30 extend through the lid 26 and the flange 28. The lid 26 may be releasably secured to the tank 12 through one or more bolts 32 placed through the holes 30. Nuts 34 may further be used to secure the bolts 32 to the lid 26 and the tank 12. Removal of the lid 26 allows for easy access to the interior of the tank 12 for cleaning, inspection, and replacement of parts.

The cathode pipe 24 passes through an opening in the lid 26 into the tank 12. A stuffing box gland assembly 36 may be used to prevent any leakage of liquid between the opening in the lid 26 and the cathode pipe 24. The stuffing box gland assembly 36 preferably is fitted with three rings of suitable gland material and adjusted to maintain a watertight seal between the lid 26 and the cathode pipe 24. Wastewater exits the cathode pipe 24 and enters the tank 12. The cathode 16 preferably comprises a cathode opening 38 through which wastewater from the cathode pipe 24 may flow through. The cathode pipe 24 may be connected to the cathode 16, either directly or indirectly through a cathode support bracket 40 that is attached to both the cathode pipe 24 and the cathode 16. Preferably, a central pipe 39 is located centrally within the cathode pipe 24 to provide a cathodic surface within the cathode pipe 24 at the level of the cathode 16. This will allow the opposing area of the anode 14 to dissolve in a more controlled manner, rather than forming a spike of undissolved anode 14 extending within the cathode pipe 24. The central pipe 39 preferably will extend from the lower surface of the cathode 16, and into the cathode pipe 24 a distance approximately equal to the diameter of the central pipe 39. The central pipe 39 may be affixed by one or more tabs 41 connecting the inside of the cathode pipe 24 with the outside of the central pipe 39. The tabs 41 may be attached to the central pipe 39 and the cathode pipe 24 by welding or bolts.

When wastewater exits the cathode pipe 24, it will be forced through the cathode opening 38, across the electrode gap 18 and onto the face of the anode 14. The wastewater will then run horizontally across the face of the anode 14 until it reaches the edge of the anode 14, at which point it will run down the space between the side of the anode 14 and the side of the tank 12. As wastewater continues to flow into the tank 12 through the cathode pipe 24, the wastewater will continue to fill the space between the side of the anode 14 and the side of the tank 12 until it reaches the top of the anode 14. At this point, the wastewater will begin to fill the region between anode 14 and the cathode 16 (i.e. the region defined by the electrode gap 18). After the region defined by the electrode gap 18 has been filled with wastewater, the wastewater will then begin to fill the space between the side of the cathode 16 and the side of the tank 12 and eventually reaches the top of the cathode 16. At this point, the wastewater continues to fill the top portion of the tank 12, over the cathode 16. When the tank 12 is filled and the wastewater continuously pumped through the tank 12, current can be applied to the anode 14 and the cathode 16 at the prescribed amperage (as discussed later).

Treated wastewater, any gasses generated by hydrolysis, any formed and forming flocs, and other products of the electrocoagulation process can exit the tank 12 through a lid opening 42 on the lid 26. These end products can exit through the lid opening 42, into an outflow pipe 44 that transports the end products away from the tank 12. The outflow pipe 44 is preferably connected to the lid 26 at a substantially perpendicular angle to the lid 26. An exit elbow 46, preferably a 90-degree angle elbow, may be used to redirect the flow to a substantially horizontal direction, into an exit pipe 48. The exit pipe 48 can be used to transport the end products away for further processing.

A direct current (DC) electrical power supply 11 supplies electrical power to the anode 14 and the cathode 16. Preferably, the power supply 11 supplies an adjustable DC current value, which may be monitored and measured by an ammeter and voltmeter. A metal anode rod 50 is preferably threaded and attached to the bottom of the anode 14. Preferably, the anode rod 50 is welded to the anode 14. This will allow for near total consumption of the anode 14 during the electrolytic process. Alternatively, the anode rod 50 may be screwed directly into the anode 14. The bottom of the tank 12 may comprise an anode opening 52 that allows for the anode rod 50 to protrude from of the tank 12. A portion of the anode rod 50 protrudes from the bottom of the tank 12 and receives a washer and threaded nut 51, which is tightened up to the tank 12 to fix the anode 14 in place and to provide a seal between the anode rod 50 and the tank 12. The anode rod 50 further comprises an anode connector surface 54 that is used to connect to the positive terminal of the power supply 11.

The negative terminal of the power supply 11 is connected to the cathode 16. Preferably, the flow entry elbow 22, the cathode pipe 24, the central pipe 39, tabs 41, and the cathode support bracket 40 are made of a conductive material and are therefore in electrical connection with the cathode 16. In such a case, the flow entry elbow 22 may comprise a cathode connector surface 56 that is used to connect to the negative terminal of the power supply 11.

As electrical power is supplied to the anode 14 and the cathode 16, the anode 14 is slowly consumed through electrolytic reactions. As the top surface of the anode 14 is closest to the cathode 16, it will be consumed first. As the top surface of the anode 14 is consumed, the distance between the top surface of the anode 14 and the bottom surface of the cathode 16 (i.e. the electrode gap 18) increases. As the electrode gap 18 increases, the resistance increases, and increased voltage must be applied in order to maintain the same amount of current. This increase in voltage increases the consumption of electricity.

In order to address this, a mechanism is needed to maintain the electrode gap 18 at a relatively constant amount. This is achieved by lowering the cathode 16 to reduce the electrode gap 18 while the anode 14 is consumed. In the preferred embodiment, a cathode rod 62 is attached to, and extends substantially vertically from, the flow entry elbow 22. The cathode rod 62 may be attached to the flow entry elbow using a lug nut 64, although other fastening or attachment mechanisms are also possible. The cathode rod 62 is threaded and is removably secured to a frame 66. The frame 66 is preferably attached to the lid 26. The cathode rod 62 is able to slide through an opening in the frame 66 and may be secured in place using adjustment nuts 68. Preferably, two adjustment nuts 68 are used: an upper adjustment nut 68a and a lower adjustment nut 68b. The adjustment nuts 68a, 68b can be rotated about the threaded cathode rod 62. As seen in FIG. 1, the adjustment nuts 68a, 68b are secured on the cathode rod 62 on opposing sides of the frame 66, holding in place in the cathode rod 62. This in turn holds in place the flow entry elbow 22, the cathode pipe 24, the cathode support bracket 40, and the cathode 16.

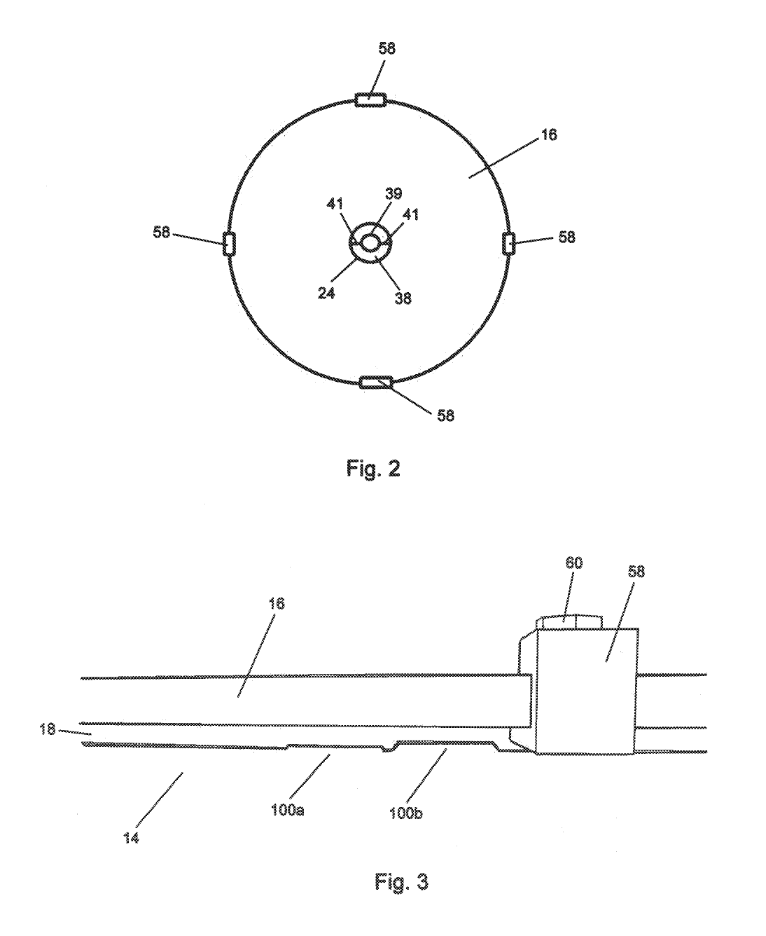

As shown in FIGS. 1 and 2, one or more spacers 58 may be placed on the outer edge of the cathode 16. FIG. 2 shows the bottom face of the cathode 16, with the spacers 58 arranged on the outer edge. The spacers 58 are made of a non-conductive material and are each preferably held in place on the cathode 16 by a fastener 60, which may be a screw or other appropriate fastening device. The spacers 58 extend below the bottom surface of the cathode 16 such that when the spacers 58 (with the attached cathode 16) are placed on the anode 14, the cathode 16 and the anode 14 will be separated by a distance equal to the distance that the spacers 58 extend below the bottom surface of the cathode 16.

Before electrical power is supplied to the anode 14 and the cathode 16, the cathode 16 is placed on top of the anode 14 such that the spacers 58 rest on the anode 14. The cathode 16 is then secured in place by tightening the adjustment nuts 68a, 68b on the cathode rod 62 against the frame 66. As the electrocoagulation process proceeds, the exposed top surface of the anode 14 (i.e. the portions of the top surface of the anode 14 not covered by the spacers 58) will be consumed, resulting in an increase in the distance between those areas of the anode 14 and the bottom surface of the cathode 16. This results in an increase in the electrode gap 18. The areas of the top surface of the anode 14 covered by the spacers 58 will be protected and will not be consumed.

In order to maintain the electrode gap 18, the cathode 16 may be lowered as follows. The lower adjustment nut 68b is first rotated downward about the cathode rod 62, free from the surface of the frame 66. The upper adjustment nut 68a is then rotated (about the cathode rod 62) in order to lift the flow entry elbow 22, the cathode pipe 24, the cathode support bracket 40, and the cathode 16 upwards enough to take the weight off the spacers 58. By applying torque on the flow entry pipe 20, the cathode 16 (through the flow entry elbow 22 and the cathode pipe 24) can be rotated. Preferably, the cathode 16 will be rotated to such a degree that the spacers 58 will be now above an area of the anode 14 that was previously exposed to electrolytic reactions (i.e. the cathode 16 is rotated for a distance that is at least equal to the width of one of the spacers 58). The upper adjustment nut 68a is then rotated about the cathode rod 62, causing the cathode rod 62, and consequently the cathode 16, to lower until the spacers 58 rest on the top surface of the anode 14. The lower adjustment nut 68b can be rotated and tightened against the frame 66 to secure the cathode rod 62 in place. If the resistance provided by the stuffing box gland assembly 36 is greater than the force supplied by gravity, the lower adjustment nut 68b may be rotated upward, pulling the cathode rod 62, and consequently the cathode 16, downward. The cathode rod 62 can then be locked in place by tightening the upper adjustment nut 68a.

The above rotation and adjustment of the cathode 16 may be repeated as required to maintain efficient electrical parameters and treatment levels.

FIG. 3 shows a side view of the anode 14 after several adjustments of the cathode 16 as described above. As seen in FIG. 3, the anode 14 is substantially flat except for raised regions 100a, 100b. These regions 100a, 100b correspond to locations on the anode 14 where the spacers 58 previously rested. As a result, the regions 100a, 100b were protected from the electrolytic reactions at the anode 14 and were not consumed. However, after rotation of the cathode 16 and the spacers 58, the regions 100a, 100b are now exposed and subject to electrolytic reactions. Furthermore, since the regions 100a, 100b are raised and are now closer to the cathode 16 than the rest of the anode 14, the regions 100a, 100b will experience less resistance and therefore more electrolytic activity. The increase in electrolytic activity will continue until the regions 100a, 100b are reduced to the same level as the rest of the anode 14. This results in a self-leveling of the surface of the anode 14. For example, as seen in FIG. 3, the region 100b is more raised than the region 100a because the region 100b was more recently protected by the spacer 58 and has been subject to a shorter period of electrolytic activity than the region 100a, which has been left unprotected for longer. The adjustment of the cathode 16 should be made when the height of the regions 100a, 100b is less the distance of the electrode gap 18.

It has been found that a current density range of 0.2 to 3.0 A/cm² of anode surface area (in opposition to a cathode surface area equal to or exceeding the same area) is effective in eliminating fouling of the surfaces of the anode 14 and the cathode 16, and preferably between 0.24 and 2.0 A/cm². When a current density of below 0.2 A/cm² is applied, the cathode 16 will harvest or collect a film of material on its surface comprised of the constituents in the wastewater and particles produced in the process. This film of material has an electrically insulating or passivating effect that causes the cathode 16 to be less conductive, thereby causing the electrocoagulation process to be less efficient. The film of material will continue to increase with continued operation until the electrode gap 18 is filled up entirely.

Also, at this level of current density (i.e. below 0.2 A/cm²), the anode 14 lacks the electrical activity required to efficiently release from its surface the anodic particles required for the electrocoagulation process. Harvested materials from the wastewater may be found in patches on the surface of the anode 14. Due to the cathode 16 fouling at the same time, the current density tends to decrease, which in turn leads to more of the surface of the anode 14 to foul.

When the electrode gap 18 is partially or nearly filled with fouling from the anode 14 or the cathode 16, electrical activity takes place in small active areas on the surfaces of the anode 14 or the cathode 16 where the current density is the highest. This results in those surfaces of anodes of typical low current density designs comprised of plates being consumed at a greater rate, leading to pitting, or uneven activity on the surface of the anodes. With continued operation, the pitting may eventually lead to perforations in the anodes. Cleaning, repair, or replacement of the anodes may be required to continue efficient wastewater treatment.

It has been found that when the current density is increased to 0.2 A/cm², the amount of fouling decreases, with substantial cessation of fouling occurring when approximately 0.3 A/cm² is reached. This substantial cessation of fouling continues as the current density increases, to 2.0 A/cm² and to 3.0 A/cm². However, at this higher end of the range, very high voltage requirements are needed to maintain this current density. However, within the range of 0.2 to 3.0 A/cm², and in particular, between 0.24 and 2.0 A/cm², the cathode 16 operates without any significant fouling on its surface, without requiring extreme voltage to maintain the current density. The cathode 16 is able to operate for extended periods with little loss of surface material. This current density range was determined, in part, using the tests described later. In addition, tests were conducted at different current densities using the preferred embodiment to determine the appropriate current density range for optimal operation.

Furthermore, the surface of the anode 14 does not experience any significant fouling as well. The shape of the surface of the anode 14 substantially follows the shape of the surface of the cathode 16 as a result of the consistently-controlled current density. If there is an irregularity on the surface of the anode 14 (such as that caused by the spacers 58 previously covering a portion of the anode 14) that results in a shorter distance to the cathode 16 than the surrounding areas, that region will experience less electrical resistance, causing an increased current density and more electrolytic activity. This in turn results in an increase in the consumption of the surface of the anode 14 in that region until parity is reached. When the electrode gap 18 is maintained (as described above) with a conductively constant treatment stream, the electrocoagulation process continues until the anode 14 is consumed evenly, without fouling.

In the preferred embodiment, the top surface of the anode 14 and the bottom surface of the cathode 16 each have an initial reactive surface area of approximately 2,920 cm², with the electrode gap 18 separation of approximately 3/16^{th} of an inch. Preferably, a current of approximately 1,000 A is applied through the anode 14 and the cathode 16, resulting in an initial current density of approximately 0.34 A/cm² of anode surface area. However, other current densities within the range 0.2 to 3.0 A/cm², and in particular between 0.24 and 2.0 A/cm², have been found to work well also, resulting in little or no fouling. The current density is preferably maintained throughout the electrocoagulation process. The voltage required to maintain this current density ranges from approximately 8 to 40 V, depending on various conditions, including the composition of the wastewater, the distance of the electrode gap 18, the desired specific current density to be used, and the surface area of the anode 14. If a current density in the upper portion of the specified range is desired (e.g. around approximately 2.0 to 3.0 A/cm²), a voltage of approximately 40 to 120 V or more may be required, depending on the electrical conductivity of the treatment stream. The anode 14 is initially approximately 3 inches thick, although it may be other thicknesses, depending on the volume of wastewater to be treated. The flow rate of wastewater entering through the tank 12 through the cathode pipe 24 is approximately 100 L/min and is determined by the treatment level required.

Although the electrode gap 18 may be maintained manually using the procedure described above, it is also possible to automate adjustment of the electrode gap 18. The use of servomechanisms, stepper motors, hydraulics and the like may be used to reposition the cathode 16 periodically by raising and lowering the cathode rod 62.

The tank 12 may further comprise a tank drain 70 extending from one side of the tank 12. The tank drain 70 may comprise a valve that can be opened to allow the contents of the tank 12 to be flushed and drained for shutdown of the cell 10, or for inspection of the anode 14 and the cathode 16. One or more legs 72 may be attached to the bottom of the tank 12 in order to elevate the tank 12 off the ground and to allow for easy access to the anode connector surface 54.

Although the current density range noted above has been discussed in connection with the preferred embodiment of the electrocoagulation cell 10, it is to be understood that using a current density range of 0.2 to 3.0 A/cm² of anode surface area (in opposition to a cathode surface area equal to or exceeding the anode surface area), and in particular between 0.24 and 2.0 A/cm², is also effective with other electrocoagulation applications in greatly reducing or eliminating fouling of the electrodes. Therefore, it is to be understood that the invention is not to be limited specifically to the electrocoagulation cell 10; indeed, it has been found that using a current density range of 0.2 to 3.0 A/cm², and in particular between 0.24 and 2.0 A/cm², is generally effective in greatly reducing or eliminating fouling of electrodes during electrocoagulation.

### Tests

As an example of the procedure to determine the appropriate current density range to use, tests were conducted on a small-scale electrocoagulation apparatus. This apparatus comprised two aluminum electrodes, each approximately 20 cm long, 2.5 cm wide, and 6 mm thick.

Oxidation on the electrodes was removed through abrasive machining to produce a flat, clean surface. The back and side surfaces, along with a portion of the top surfaces, of the electrodes were sealed with an epoxy, those exposing an active electrode area of approximately 33.33 cm² on each electrode. The electrodes were held apart by a 6 mm rubber spacer.

The electrodes were placed in approximately 80 L of seawater, with a pH value of approximately 7.4 and a temperature of 20° C. DC power was supplied to the electrodes by a power supply, with the amperage controlled by an adjustable rheostat. The current levels were set by an amperage gauge on the power supply and confirmed with a calibrated handheld DC current meter.

DC power was applied continuously at the predetermined amperages for 120 minutes. Flow over the electrode surfaces was supplied by the rising column of hydrogen and oxygen gases generated during the hydrolyzing of the seawater on the electrodes. After 120 minutes, the electrodes were removed and visually inspected for surface accumulations. Fouling was considered to be any surface accumulations of material deposited during the tests. Any fouling would have had the effect of reducing the normal electrolytic dissolution of the anode surface. The results are shown in Table 1.

TABLE 1
Effect of Current Density on Fouling

| | Active | | | |
|---|---|---|---|---|
| Current | Surface Area | Current | | |
| Applied | of Electrode | Density | Observations at | Observations at |
| (A) | (cm²) | (A/cm²) | Anode | Cathode |
| 8 | 33.3333 | 0.24 | 60% pitted and | 60% grey, smooth; |
| | | | very rough; | 40% grey specks |
| | | | 40% fouled and | |
| | | | passivated | |
| 9 | 33.3333 | 0.27 | 80% smooth and | 60% grey, smooth; |
| | | | bare; | 40% grey specks |
| | | | 20% fouled and | |
| | | | passivated | |
| 10 | 33.3333 | 0.30 | 90% very clean | 40% grey, smooth; |
| | | | and metallic; | 60% grey specks |
| | | | 10% fouled and | |
| | | | passivated | |
| 11 | 33.3333 | 0.33 | 97% clean | 40% grey, smooth; |
| | | | metallic surface; | 60% grey specks |
| | | | 3% fouled and | |
| | | | passivated | |
| 12 | 33.3333 | 0.36 | 100% very | 90% grey, smooth; |
| | | | clean metallic; | 10% grey specks |
| | | | 0% fouling | |

As seen in Table 1, improvement in fouling begins from 0.24 A/cm² as the current density increases, with substantially all fouling being eliminated at 0.33 A/cm². No fouling at the anode is observed at 0.36 A/cm². At higher current densities, no fouling is observed, but the voltage requirements for maintaining such high current densities may be impractical or unsafe (such as above 3.0 A/cm²).

It will be appreciated by those skilled in the art that the preferred and alternative embodiments have been described in some detail but that certain modifications may be practiced without departing from the principles of the invention.

1. A system for treating wastewater, said system comprising:
an anode comprising an anode surface, said anode surface having an anode surface area;
a cathode comprising a cathode surface, said cathode surface having a cathode surface area greater than or equal to said anode surface area;
a power supply connected to said anode and said cathode, wherein said power supply provides direct current to said anode and said cathode at a current density effective to reduce fouling of said anode and said cathode, said current density being between 0.2 and 3.0 A/cm² of said anode surface area; and
wherein said wastewater provides electrical conductivity between said anode surface and said cathode surface.

2. The system of claim 1, wherein said current density is between 0.24 and 2.0 A/cm².

3. The system of claim 1, said system further comprising:
a tank, wherein said anode and said cathode are placed in said tank and wherein said cathode is moveable within said tank; and
one or more non-conductive spacers separating said anode surface from said cathode surface, wherein said one or more spacers are attached to said cathode and are moveable along said anode surface.

4. The system of claim 3, wherein said cathode is substantially cylindrical and is moveable within said tank in a rotational manner about an axis of said cathode.

5. The system of claim 1, wherein said anode is comprised of one of the following materials: aluminum alloy, aluminum, or iron.

6. The system of claim 1, wherein said cathode is comprised of one of the following materials: aluminum, bronze, iron, steel, or stainless steel.

7. The system of claim 4, wherein said cathode comprises an opening through which said wastewater flows.

8. The system of claim 7 further comprising a cathode pipe introducing said wastewater into said tank.

9. The system of claim 8, wherein said cathode pipe is connected to said cathode.

10. The system of claim 9, wherein said cathode is moveable within said tank through rotation of said cathode pipe.

11. The system of claim 10, wherein said cathode pipe comprises an inner pipe located within an interior of said cathode pipe.

12. A method for treating wastewater using electrocoagulation, said method comprising the steps of:
providing an anode comprising an anode surface having an anode surface area;
providing a cathode comprising a cathode surface having a cathode surface area greater than or equal to said anode surface area;
introducing said wastewater to provide electrical conductivity between said anode surface and said cathode surface; and
applying direct current to said cathode and said anode, said direct current having a current density effective to reduce fouling of said cathode and said anode, said current density being between 0.2 and 3.0 A/cm² of said anode surface area.

13. The method of claim 11, wherein said current density is between 0.24 and 2.0 A/cm².

14. The method of claim 12, further comprising the step of placing said cathode on said anode in a tank, wherein said cathode surface and said anode surface are separated by one or more non-conductive spacers and wherein said one or more spacers are connected to said cathode and rest on said anode surface.

15. The method of claim 14, further comprising the step of periodically moving said cathode such that said one or more spacers move along said anode surface.

16. The method of claim 14, wherein said step of introducing said wastewater to provide electrical connectivity between said anode surface and said cathode surface comprises filling said tank with said wastewater.

17. The method of claim 15, wherein said step of periodically moving said cathode comprises periodically moving said cathode a distance at least equal to the width of one of said one or more spacers.

18. The method of claim 17, wherein said step of periodically moving said cathode further comprises periodically rotating said cathode.

19. The method of claim 18, wherein said step of periodically rotating said cathode comprises rotating a cathode pipe connected to said cathode.

20. The method of claim 19, wherein said cathode pipe transports said wastewater into said tank.

21. The method of claim 20, wherein said wastewater flows through said cathode pipe and through an opening in said cathode.

22. The method of claim 12, wherein said anode is comprised of one of the following materials: aluminum alloy, aluminum, or iron.

23. The method of claim 12, wherein said cathode is comprised of one of the following materials: aluminum, bronze, iron, steel, or stainless steel.
